(19) United States
(12) Patent Application Publication
(10) Pub. No.: US 2006/0165064 A1
(43) Pub. Date: Jul. 27, 2006

(54) Method and apparatus for a network element to track the availability of other network elements

(76) Inventors: John C. Brown, Freehold, NJ (US); Gerald L. Hoover, Red Bank, NJ (US); Mrinalini Natarajan, Morganville, NJ (US); Robert Peters, Rumson, NJ (US); Mark Ratcliffe, Oakhurst, NJ (US); Harish Samarasinghe, Holmdel, NJ (US)

Correspondence Address: Mr. S.H. Dworetsky;AT & T Corp., Room 2A-207, One AT&T Way, Bedminster, NJ, 07921, US

(21) Appl. No.: 11/253,269

(22) Filed: Oct. 18, 2005

Related U.S. Application Data
(60) Provisional application No. 60/622,041, filed on Oct. 26, 2004.

(51) Int. Cl. H04L 12/66

(52) U.S. Cl. 370/352; 370/401

(57) ABSTRACT

A method and apparatus for enabling a network element to use network resources efficiently by tracking the availability of other network elements are disclosed. In one embodiment, the present method utilizes one or more SIP method OPTIONS messages to determine the availability of a target network element.

This application claims the benefit of U.S. Provisional Application No. 60/622,041 filed on Oct. 26, 2004, which is herein incorporated by reference.

The present invention relates generally to communication networks and, more particularly, to a method and apparatus for enabling a network element to efficiently use network resources by tracking the status of other network elements in packet networks, e.g., Voice over Internet Protocol (VoIP) and Service over Internet Protocol (SoIP) networks.

### BACKGROUND OF THE INVENTION

The Internet has emerged as a critical communication infrastructure, carrying traffic for a wide range of important scientific, business and consumer applications. Since Internet services are becoming ubiquitous, more and more businesses and consumers are relying on their Internet connections for both voice and data transport needs. The amount of traffic transported on the network continues to grow. Each component of the network is shared by a large number of businesses and consumers. Network service providers and enterprise network operators need to use network resources efficiently in order to facilitate a high quality of service and customer experience.

The availability and reliability of the service impact the customer experience. When call attempts fail to complete, for example due to failures of network elements or bandwidth limitations, the call is sent to another network element that may be able to complete the call. The service is interrupted or delayed at best. Since the status of the network elements are not known, the network resources are not efficiently used.

Therefore, service providers and enterprise network operators need a method and apparatus for determining the availability of network resources prior to initiating a call.

### SUMMARY OF THE INVENTION

In one embodiment, the present invention discloses a method and apparatus for a network element to track the availability of other network elements in a packet network, e.g., an Internet Protocol (IP) network. In one embodiment, the source network element sends Session Initiation Protocol (SIP) method OPTIONS to selected target network elements and gathers the responses. The response or lack of response to the SIP method OPTIONS is used to determine whether the network element is available or unavailable to receive calls. In turn, call messages are sent only to available network elements. Thus, the present method would enable a service provider to provide a higher quality of service by improving the availability of the network and utilizing network resources efficiently. The present method facilitates network resource management.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates a VoIP core network with network elements capable of tracking availability of other network elements;

FIG. 3 illustrates a flowchart of a method for a network element to track the availability of other network elements; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for a network element to track the availability of other network elements in an IP network such as a VoIP network or a SoIP network. Although the present invention is discussed below in the context of an IP network and Session Initiation Protocol (SIP), the present invention is not so limited. Namely, the present invention can be adapted in other communications infrastructures such as a PSTN network using the SS7 protocol. Namely, the present invention can be adapted to other communication protocols that have equivalent message classes as discussed below.

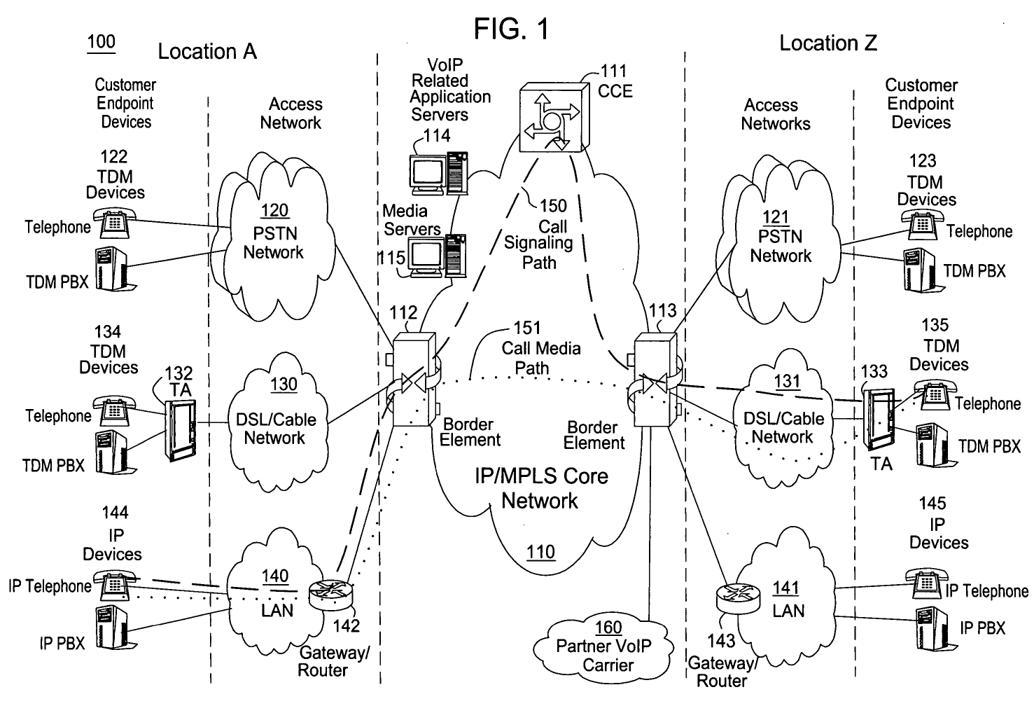

To better understand the present invention, FIG. 1 illustrates a communication architecture 100 having an example network, e.g., a packet network such as a VoIP network related to the present invention. Exemplary packet networks include internet protocol (IP) networks, asynchronous transfer mode (ATM) networks, frame-relay networks, and the like. An IP network is broadly defined as a network that uses Internet Protocol to exchange data packets. Thus, a VoIP network or a SoIP (Service over Internet Protocol) network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted to be limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP based core backbone network 110. The CCE is typically implemented as a Media Gateway Controller and performs network wide call control related functions as well as interacts with the appropriate VoIP service related servers when necessary. The CCE functions as a SIP back-to-back User Agent (UA) and is a signaling endpoint for all call legs between all BEs and the CCE. The CCE may need to interact with various VoIP related servers in order to complete a call that requires certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112, as the user agent, will then send a setup-signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111, as the back-to-back user agent, sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

The above exemplary VoIP network is described to provide an illustrative environment in which a large quantity of requests for call setup, namely signaling messages such as SIP-invite, can be exchanged between network elements such as BEs, CCEs and application servers. When network elements sending the SIP-invite do not receive a response for the request from the target network element, call setup messages are sent to other network elements that may be able to complete the call and the call is routed using another path away from the failure. However, the call set-up is delayed and the quality of service provided to the customer is impacted. Furthermore, since a significant number of call setup requests are unsuccessful, the network resources are not used efficiently.

Therefore, it would be advantageous to have a method and apparatus for a network element to track availability of other network elements it communicates with prior to initiating a call. Such method would enable the service provider to provide a high quality of service by improving the availability of the network and utilizing network resources efficiently.

In order to clearly illustrate the present invention, the following IP network related concepts will first be described. These concepts are that of:

Session Initiation Protocol (SIP); and

SIP method OPTIONS.

Session Initiation Protocol (SIP) is an application layer signaling protocol for creating, modifying and terminating sessions with one or more participants. For example, SIP invitations used to create sessions carry session descriptions that allow participants to agree on a set of compatible media types. SIP is a protocol that provides the capability to deliver a variety of services such as voice, data, wireless etc. services over a common network.

SIP method OPTIONS (or OPTIONS methods) are a type of SIP messages sent to other network elements such as servers to query the network elements' capabilities without setting up a call to the targeted network element. This allows the source network element to discover information about the methods supported by the destination network element such as content types, extensions, etc. prior to sending a SIP-invite message. All user agents support SIP method OPTIONS.

Table 1 illustrates an example of a SIP method OPTIONS message (e.g., broadly defined as an options message) sent by a source network element and the associated response from a destination network element.

TABLE 1

| Transmitted SIP method OPTIONS message | Received response to the message |
|---|---|
| OPTIONS sip: AS1 @ AS_IP_Address.att.com:5060;user=phone SIP/2.0 | SIP/2.0 200 OK |
| Via: SIP/2.0/UDP SB_IP_Address.att.com:5060 | Via: SIP/2.0/UDP SB_IP_Address.att.com:5060 |
| From: “user” <sip:36602@ SB_IP_Address.att.com> | From: “user” <sip:36602@ SB_IP_Address.att.com> |
| To: <sip:AS1 @ AS_IP_Address.att.com> | To: <sip:AS1 @ AS_IP_Address.att.com> |
| Call-ID: s9111s488@ SB_IP_Address.att.com | Call-ID: s9111s488@ SB_IP_Address.att.com |
| Cseq: 110 OPTIONS | Cseq: 110 OPTIONS |
| Contact: <sip:AS1 @ AS_IP_Address.att.com:5060> | Supported: 100rel |
| Cntent-Length: 0 | Content-Length: 0 |

The present invention discloses a method and apparatus for a network element to track the availability of other network elements in an IP network by sending SIP method OPTIONS to selected target network elements and gathering the responses. The network elements are chosen based on a history of communication with the sender. The response or lack of response to the SIP method OPTIONS is used to determine whether the network element is available or unavailable to receive a call. In turn, call setup messages are sent only to available network elements.

Although the present invention is described in terms of using SIP method OPTIONS messages to track availability of other network elements, the present invention is not so limited. Namely, the present invention can be implemented using any protocol such as Hyper Text Transport Protocol (HTTP), Simple Mail Transfer Protocol (SMTP), etc.

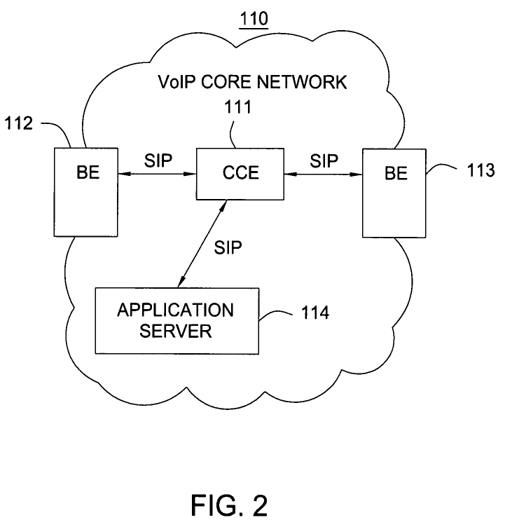

FIG. 2 illustrates an exemplary VoIP core network 110 with elements that have the ability to track the availability of other network elements. The network may contain BEs 112 and 113, CCE 111 and VoIP related application servers 114. To illustrate, the BEs may send SIP messages to the CCE 111 for the sole purpose of track the availability of the CCE 111. Similarly, since the CCE is in communication with all the BEs, and the application servers, the CCE is also able to track the status of the various types of network elements through the use of SIP messages. Similarly, this capability is accorded to the application servers to track the availability of the CCE and the BEs. Specifically, in one embodiment, each network element sends one or more SIP method OPTIONS to the other network elements by utilizing standard SIP messages for the purpose of track the availability of the target network element. Thus, the present invention requires no customization of messages exchanged between the network elements. The destination network elements may simply respond with standard SIP response messages such as 200 OK.

The source network element for the SIP method OPTIONS message gathers the responses, determines the status of each of the destination network elements and maintains a list of available and unavailable network elements. For example, if no response is received from a network element within a specific amount of time, it is listed as unavailable. The service provider determines the time interval and the number of messages (e.g., three consecutive messages without receiving the expected responses) required for concluding that a network element is unavailable. In turn, call setup messages are sent only to available network elements.

In one embodiment, the source network element continues to periodically send the SIP method OPTIONS to the unavailable network elements for a specific period of time. This allows the source network element to detect if and when a target network element becomes available again, thereby allowing the source network element to begin sending call setup messages as soon as the network element becomes available. The service provider determines the period of time and the frequency for continuing the SIP method OPTIONS messages to network elements on the unavailable resource list.

If a response is not received from the unavailable network element during the specified time, the network element that initiated the SIP method OPTIONS message removes the unavailable network element from its list and ends further transmission of SIP method OPTIONS messages to that network element. In one embodiment, the network element that initiated the SIP method OPTIONS message also notifies the network operator of the failure. The service provider determines the time interval that should elapse before notifying the network operator.

However, if a response is received from a previously unavailable network element, then the source network element will then update its list to indicate that the target network element is now available. Again, the service provider may determine the time interval and the number of messages (e.g., three consecutive messages with the receipt of the expected responses) required for concluding that a network element is available.

In one embodiment, the method of the present invention for tracking the availability of other network elements is configurable by the service provider based on the supported applications and other business processes. For example, if the service provider prefers that BE 112 continue sending the SIP method OPTIONS messages regardless of the status of the receiving network element, the time can be set to indefinite.

The configuration includes parameters such as the time interval and number of messages for declaring a network element as unavailable, the period of time and frequency for continuing SIP method OPTIONS requests to unavailable network elements, time interval to notify the network operator about unavailability of network elements, the number of consecutive responses and time interval to move a network element from unavailable list to available list, etc. The parameters described above are not intended to be a complete list of all configurable parameters. It is intended to represent examples of functionalities to include in the user configurable portion of the present invention.

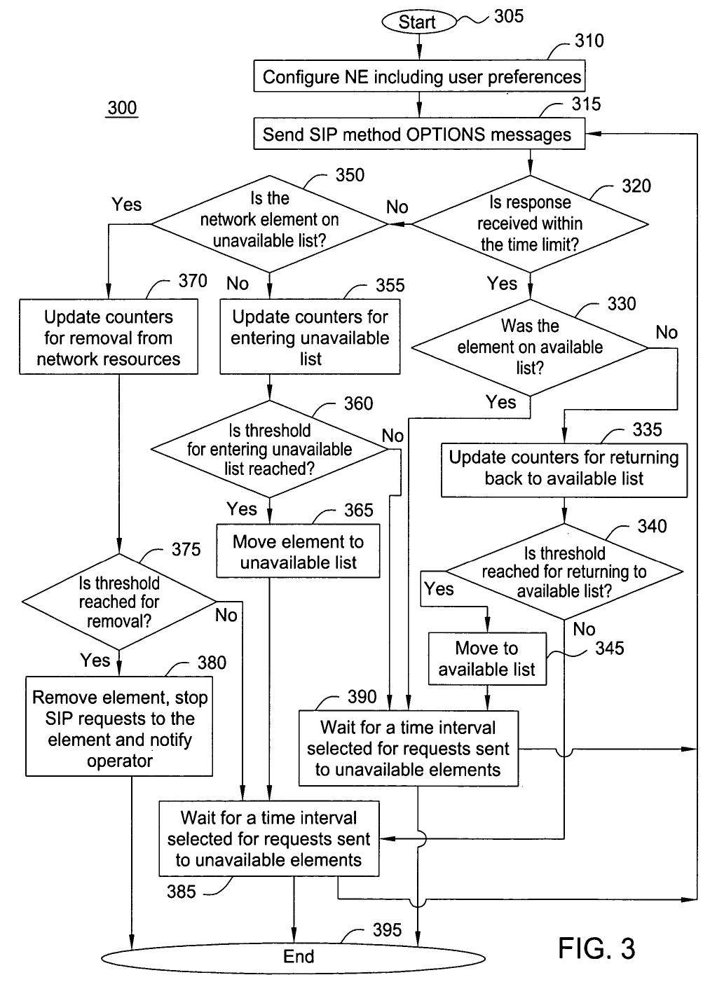

FIG. 3 illustrates a flowchart of a method 300 for a source network element to track the availability of other target network elements. Method 300 starts in step 305 and proceeds to step 310.

In step 310, method 300 configures the network element and enters the user preferences. For example, the configurable parameters may include the time interval and number of messages for declaring a network element as unavailable, the period of time and frequency for continuing SIP method OPTIONS requests to unavailable network elements prior to removal from resource lists, time interval to notify the network operator about unavailability of network elements, the number of consecutive responses and time interval to move a network element from the unavailable list to the available list and so on.

The initial list of network elements to be targeted for tracking can be established either by manual entry by the network operator or automatically from history of communication and/or standard network discovery methods. The method then proceeds to step 315.

In step 315, method 300 sends a SIP method OPTIONS message to a target network element, e.g., on the available list or unavailable list. The time between transmitted requests and the number of requests is chosen based on the last known status of the network element and the preferences provided in step 310.

In step 320, method 300 determines whether a response is received from the target network element within the applicable time interval. If a response is received the method proceeds to step 330 to determine whether the network element was on the available network elements list or it needs to be moved to the list. If no response is received, the method proceeds to step 350 to determine whether the network element is on the unavailable network elements list.

In step 330, method 300 determines whether the network element was on the available list or unavailable list. If it is on the available list, the method proceeds to step 390 to begin the process for the next SIP method OPTIONS transmission for available network elements or to end the process for the current request. If the network element is not on the available list, method 300 proceeds to step 335.

In step 335, method 300 updates the counters used for exiting the unavailable list and returning to the available list. The method then proceeds to step 340.

In step 340, method 300 determines if the threshold has been reached for returning an unavailable network element back to the available list according to the preferences entered in step 310. If the threshold has not been reached, the method proceeds to step 385 to begin the process for the next SIP method OPTIONS transmission for unavailable network elements or to end the process for the current request. If the threshold has been reached, the method proceeds to step 345.

In step 345, method 300 moves the network element back to the available list and proceeds to step 390 in order to begin the process for the next SIP method OPTIONS transmission or to end the process for the current request.

In step 350, method 300 determines whether the network element is on the unavailable list or not. If the target network element is on the unavailable list, it proceeds to step 370 to update the counters for removal from the resource list. If the network element is not on the unavailable list, it proceeds to step 355.

In step 355, method 300 updates the counters used to enter the unavailable list and proceeds to step 360.

In step 360, method 300 determines if the threshold for entering the unavailable list has been reached. If the threshold is not reached, the method proceeds to step 390 to begin the process for the next SIP method OPTIONS transmission for available network elements or to end the process for the current request. If the threshold is reached, the method proceeds to step 365.

In step 365, method 300 moves the target network element to the unavailable list and proceeds to step 385 to begin the process for the next SIP method OPTIONS transmission for unavailable network elements or to end the process for the current request.

In step 370, method 300 updates the counters used for removing the network element from resources list and proceeds to step 375.

In step 375, method 300 determines whether the threshold has been reached to remove the network element from the resources list. If the threshold has not been reached, it proceeds to step 385 to begin the process for the next SIP method OPTIONS transmission for unavailable network elements or to end the process for the current request. If the threshold has been reached the method proceeds to step 380.

In step 380, method 300 removes the target network element from the resources list, stops sending the SIP method OPTIONS messages to the target network element and/or notifies the network operator about the failure. It should be noted that sending an alarm for notifying the network operator is an optional step. However, such notification can be used to minimize network outage times and to improve the efficiency of the network. Thus, in one embodiment, the source network element notifies the network operator using the preferences as configured in step 310. The method then proceeds to step 395.

In step 385, method 300 begins the process for the next SIP method OPTIONS transmission for unavailable network elements by waiting for the next time intervals. The method then proceeds to step 315 to send the next request or to step 395 to end the process for the current request.

In step 390, method 300 begins the process for the next SIP method OPTIONS transmission for available network elements by waiting for the next time interval for available network elements. The method then proceeds to step 315 to send the next request or to step 395 to end the process for the current request.

Note that the network element does not have to send the SIP method OPTIONS messages to all the other network elements at the same time. The messages can be staggered over time and separate counters can be used for each tracked network element. Thus, the present invention provides a method for a network element to track the availability of other network elements, thereby allowing call setup messages to be sent only to the available network elements.

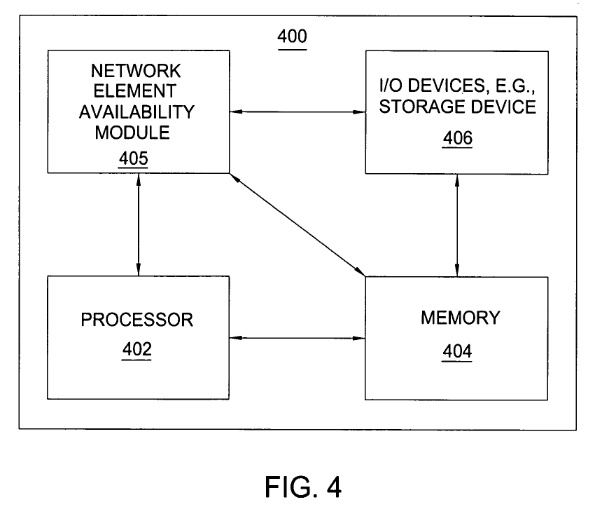

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for tracking the availability of other network elements, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module for tracking availability of other network elements or process 405 can be loaded into memory 404 and executed by processor 402 to implement the functions as discussed above. As such, the present method 405 for tracking availability of other network elements (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for determining availability of a network element in a communication network, comprising:
sending at least one options message to a target network element;
waiting a predefined period of time for a response from said target network element; and
determining availability of said target network element in accordance with whether said response from said target network element is received.

2. The method of claim 1, wherein said communication network is a Voice over Internet Protocol (VoIP) network or a Service over Internet Protocol (SoIP) network.

3. The method of claim 1, wherein said at least one options message is at least one Session Initiation Protocol (SIP) method OPTIONS message.

4. The method of claim 1, wherein said at least one options message comprises a plurality of options messages, and wherein said availability of said target network element is determined in accordance with whether a corresponding plurality of responses from said target network element is received.

5. The method of claim 1, further comprising:
maintaining a list of available target network elements; and
maintaining a list of unavailable target network elements.

6. The method of claim 5, where said target network element is on said list of unavailable target network elements or is on said list of unavailable target network elements.

7. The method of claim 6, further comprising:
moving said target network element onto said list of unavailable target network elements if it is determined that said target network element is unavailable.

8. The method of claim 7, wherein said target network element is determined to be unavailable if said target network element fails to respond to a plurality of consecutive options messages.

9. The method of claim 6, further comprising:
moving said target network element onto said list of available target network elements if it is determined that said target network element is available.

10. The method of claim 9, wherein said target network element is determined to be available if said target network element succeeds in responding to a plurality of consecutive options messages.

11. The method of claim 1, wherein said at least one options message is a message for inquiring about capability of said target network element.

12. A computer-readable medium having stored thereon a plurality of instructions, the plurality of instructions including instructions which, when executed by a processor, cause the processor to perform the steps of a method for determining availability of a network element in a communication network, comprising:
sending at least one options message to a target network element;
waiting a predefined period of time for a response from said target network element; and
determining availability of said target network element in accordance with whether said response from said target network element is received.

13. The computer-readable medium of claim 12, wherein said communication network is a Voice over Internet Protocol (VoIP) network or a Service over Internet Protocol (SoIP) network.

14. The computer-readable medium of claim 12, wherein said at least one options message is at least one Session Initiation Protocol (SIP) method OPTIONS message.

15. The computer-readable medium of claim 12, wherein said at least one options message comprises a plurality of options messages, and wherein said availability of said target network element is determined in accordance with whether a corresponding plurality of responses from said target network element is received.

16. The computer-readable medium of claim 12, further comprising:
maintaining a list of available target network elements; and
maintaining a list of unavailable target network elements.

17. The computer-readable medium of claim 16, where said target network element is on said list of unavailable target network elements or is on said list of unavailable target network elements.

18. The computer-readable medium of claim 17, further comprising:
moving said target network element onto said list of unavailable target network elements if it is determined that said target network element is unavailable; or
moving said target network element onto said list of available target network elements if it is determined that said target network element is available.

19. The computer-readable medium of claim 18, wherein said target network element is determined to be unavailable if said target network element fails to respond to a plurality of consecutive options messages; or wherein said target network element is determined to be available if said target network element succeeds in responding to a plurality of consecutive options messages.

20. An apparatus for determining availability of a network element in a communication network, comprising:
means for sending at least one options message to a target network element;
means for waiting a predefined period of time for a response from said target network element; and
means for determining availability of said target network element in accordance with whether said response from said target network element is received.
